(19) United States
(12) Patent Application Publication
(10) Pub. No.: US 2007/0257634 A1
(43) Pub. Date: Nov. 8, 2007

(54) SELF-POWERED PORTABLE ELECTRONIC DEVICE

(76) Inventors: Stephen Joseph Leschin, Le Grand, IA (US); Richard B. Cass, Ringoes, NJ (US); Farhad Mohammadi, Westampton, NJ (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 11/745,222

(22) Filed: May 7, 2007

Related U.S. Application Data
(60) Provisional application No. 60/797,962, filed on May 5, 2006.

(51) Int. Cl. H02J 7/00

(52) U.S. Cl. 320/107

(57) ABSTRACT

The present invention is directed to devices, systems, and methods having energy harvesting capabilities for self-powering portable electronic devices. The energy harvesting system preferably includes piezoelectric ceramic fibers that harvest mechanical energy to provide electrical energy or power to operate one or more features of the portable electronic device. The piezoelectric ceramic fibers may be in and/or on a structure of a portable electronic device and/or auxiliary devices/structures associated with a portable electronic device. The piezoelectric ceramic fibers allow generation of charge from mechanical inputs seen in everyday use of the portable electronic device and provide for the collection of generated energy. The energy harvesting capabilities also provide for conversion and storage of the harvested energy as electrical energy that may be used for powering one or more features of the portable electronic device. The piezoelectric ceramic fiber energy harvesting system may reduce and/or eliminate the need for external power sources and/or battery power.

### CROSS-REFERENCE TO RELATED APPLICATIONS

This application claims the benefit of application Ser. No. 60/797,962, filed May 5, 2006, the entirety of which is incorporated herein by reference.

### TECHNOLOGY FIELD

The subject matter described herein relates generally to self-powered devices and systems, and in particular to devices and systems having piezoelectric materials for the harvesting of mechanical energy and conversion of the mechanical energy into usable electrical energy for powering a portable electronic device.

### BACKGROUND

One of the biggest problems in designing and operating electronic devices is power. One manner in which to power an electronic device is for the device to be connected to an external source of electric power, such as, for example, a power cord connected to the device that can be plugged into a wall receptacle. A problem with electronic devices that must be physically connected to an external and fixed power source is that these electronic devices are tethered to the power source and hence are not portable.

For portable electronic devices the power problem is even more pronounced. The most common power source for portable electronic devices is batteries. Typically, the batteries may be replaceable or rechargeable. With replaceable batteries, the batteries contained in the electronic devices are depleted or exhausted as the device operates and consumes power. As a result, the batteries need to be continuously monitored and replaced periodically. Monitoring batteries is inconvenient and replacing batteries can be expensive.

Similar to replaceable batteries, rechargeable batteries contained in electronic devices are also depleted or exhausted as the device operates and consumes power. As a result, the device must be connected to an external power source so that the batteries may be recharged periodically. While the batteries are being recharged, the electronic device is no longer portable. Recharging batteries is also inconvenient.

If the user forgets to replace and/or recharge low batteries, then the electronic device may not work properly, and in the case of depleted batteries the device may not work at all. This can be burdensome and inconvenient for the user of the portable wireless device if the batteries drain at unexpected and/or inappropriate times.

Another disadvantage of batteries for powering an electronic device is that batteries typically take up a significant amount of space and add unwanted weight to the portable electronic device. This results in the wireless device being larger and heavier than similar devices not having batteries. In addition, batteries are expensive and can add significantly to the cost of purchasing and operating a portable electronic device.

Energy harvesting systems for self-powering devices are known. For example, harvesting kinetic energy from vibrations in the environment using electromechanical system consisting of an arrangement of magnets on a vibrating beam is known. As the device vibrates, the magnets move past a coil generating power for small sensors, microprocessors, and transmitters. These electromechanical systems, however, are relatively large in size, heavy in weight, and expensive. In addition, electromechanical energy harvesting systems are relatively inefficient at harvesting, converting, and storing power.

For example, U.S. Pat. No. 6,943,476, entitled “MAGNETO GENERATOR FOR SELF-POWERED APPARATUSES” and issued to Regazzi, et al. discloses a magneto generator for self-powered apparatuses. The magneto generator of Regazzi, et al. comprises a stator provided with an electric winding, and a permanent magnet rotor coaxially arranged to the stator. The stator and the rotor have a first, and respectively a second pole system which together with the electric winding define a multiphase electromagnetic system connected to a bridge rectifier, secured to the stator. The poles of the stator and the poles of the rotor have opposite polar surfaces in which the axis of each polar surface of the rotor is slanted with respect to a reference line parallel to the longitudinal axes of the polar surfaces of the stator.

In addition, harvesting energy from a flow of water in the environment is known. For example, U.S. Pat. No. 6,927,501, entitled “SELF-POWERED MINIATURE LIQUID TREATMENT SYSTEM” and issued to Baarman, et al. discloses a liquid treatment system that may be self-powered and includes a filter, an ultraviolet light source and a hydro-generator in the fluid flow path. The housing may be mounted at the end of a faucet. The hydro-generator may generate electric power for use by the ultraviolet light source and a processor. But a water source is an unreliable and inconvenient source for harvesting energy.

Further, harvesting solar or light energy is known. In theory, devices having solar cells never need batteries and can work forever. Photovoltaic cells or modules (a grouping of electrically connected cells) can be provided in a device to convert sunlight into energy for powering a device. However, because the sun does not always shine, i.e., at night and during cloudy days, and auxiliary sources of light energy are not always available, this type of self-power is not reliable. Also, solar cells are relatively inefficient energy harvesters. Typically, solar systems include some type of energy storage (e.g., batteries) as a back-up system for providing power when the sun isn't shining. The various disadvantages of batteries and battery-life issues have been discussed supra.

An example of a self-powered solar system includes U.S. Pat. No. 6,914,411, entitled “POWER SUPPLY AND METHOD FOR CONTROLLING IT” and issued to Couch et al. Couch et al. discloses a self-powered apparatus including a solar power cell, a battery, and a load. The load may include one or more load functions performed using power provided by one or both of the solar power cell and the battery. Switching circuitry, controlled by the programmable controller, selectively couples one or both of the battery and the solar cell to supply energy for powering the load. In a preferred embodiment taught by Couch et al., the controller couples the battery and/or solar cell to charge a super capacitor, which then is selectively controlled to power the load. A solar source for harvesting energy is unreliable and inconvenient in that it requires outdoor use in the sun or a separate light source.

Further, certain materials (e.g., quartz and Rochelle salts, and bulk ceramic materials) are known to produce a voltage between surfaces of a solid dielectric when a mechanical stress is applied to it. This phenomenon is known as the piezoelectric effect and may be used to produce a small current as well. Conventional piezoelectric ceramic materials are typically produced in block form. These blocks of piezoelectric ceramic materials are rigid, heavy, and brittle. Bulk piezo ceramics are also expensive to produce/machine, are limited in size, and require re-enforcement or anti-fracturing structures. In addition, conventional bulk piezo ceramics typically have a relatively low output power.

Other examples of energy harvesting include hand cranked devices, such as hand cranked radios, and wind driven devices, such as windmills, and the like.

What is needed are self-powered electronic devices, systems, and methods that present a solution to at least one of the problems existing in the prior art. Further, self-powered electronic devices, systems, and methods that solve more than one or all of the disadvantages existing in the prior art while providing other advantages over the prior art would represent an advancement in the art.

### SUMMARY

In view of the above shortcomings and drawbacks, devices, systems, and methods for self- powering portable electronic devices are provided. This technology is particularly well-suited for, but by no means limited to, self-powered portable wireless device, such as cellular telephones.

One embodiment of the present invention is directed to a self-powered, portable electronic device. The self-powered, portable electronic device includes a housing for containing electrical components and electrical circuitry associated with operation of the portable electronic device. The self-powered, portable electronic device includes one or more electrical loads. Ambient sources of mechanical energy may be associated with handling and operation of the portable electronic device. An energy harvesting system is provided comprising piezoelectric ceramic material that may be electrically coupled to one or more of the loads of the portable electronic device. The piezoelectric ceramic material energy harvesting system converts mechanical energy into electrical energy for powering one or more of the electrical loads without use of external power supplies and/or replaceable batteries.

According to another aspect of the invention, the piezoelectric ceramic material further comprises piezoelectric ceramic fibers. The piezoelectric ceramic fibers may further comprise one or more of: a piezoelectric fiber composite (PFC); a piezoelectric fiber composite bimorph (PFCB); and/or a piezoelectric multilayer composite (PMC).

According to another aspect of the invention, the piezoelectric ceramic material further comprises one or more of fibers, rods, foils, composites, and multi-layered composites.

According to one embodiment of the invention, the piezoelectric ceramic material energy harvesting system reduces a dependency of the portable electronic device on external and/or replaceable power supplies. According to another embodiment of the invention, the piezoelectric ceramic material energy harvesting system eliminates any dependency of the portable electronic device on external and/or replaceable power supplies.

According to another aspect of the invention, the one or more electrical loads further comprise low or ultra low power electronics.

According to another aspect of the invention, the piezoelectric ceramic material further comprises flexible, high charge piezoelectric ceramic fibers produced using Viscose Suspension Spinning Process (VSSP).

According to another aspect of the invention, the piezoelectric ceramic material further comprise user defined shapes and/or sizes.

According to another aspect of the invention, the piezoelectric ceramic material may be one or more of embedded within, disposed within, and/or attached to the portable electronic device.

According to another aspect of the invention, the piezoelectric ceramic material may be embedded within, disposed within, and/or attached to one or more of: the housing, a cover, a keypad, a push button, a slide button, a switch, a printed circuit board, a display screen, a ringer, a microphone, a speaker, an antenna, a holster, a carrying case, a belt, a belt clip, a stand, a stylus, and/or a mouse.

According to another aspect of the invention, the piezoelectric ceramic material may be one or more of embedded within, disposed within, and/or attached to a device or structure associated with the portable electronic device. The portable electronic device may be electrically coupled to the device or structure associated with the portable electronic device to receive a charge from the device or structure associated with the portable electronic device.

According to another aspect of the invention, the piezoelectric ceramic material generates an electrical charge in response to an applied mechanical energy input resulting from one or more of human activity and/or operation of the portable electronic device. The electric charge may be proportional to the applied mechanical energy input.

In another embodiment of the invention, an energy storage device may be provided and may be electrically coupled to the piezoelectric ceramic fibers for storing harvested energy. A rectifier may be provided to convert the energy from alternating current (AC) to direct current (DC) prior to storage in the energy storage device. The energy storage device may further comprise one of a rechargeable battery, a capacitor, and/or a super capacitor.

According to another aspect of the invention, the piezoelectric ceramic fibers may be positioned and oriented such that mechanical energy input is parallel to a longitudinal axis of the fibers.

According to another aspect of the invention, the piezoelectric ceramic fibers may be positioned and oriented having a maximum longitudinal length, wherein the maximum longitudinal length of the piezoelectric ceramic fibers provides maximum power generation and harvesting.

According to another aspect of the invention, the piezoelectric ceramic fibers may be positioned and oriented having a maximum number and concentration, wherein the maximum number and concentration of the piezoelectric ceramic fibers provides maximum power generation and harvesting.

According to another aspect of the invention, the piezoelectric ceramic fibers may be oriented in parallel array with a poling direction of the fibers being in the same direction.

According to another aspect of the invention, adjacent piezoelectric ceramic fibers may be in contact with one another.

According to another aspect of the invention, the piezoelectric ceramic fibers may be oriented in a star array having a center and individual fibers extending outward from the center. A poling direction of the fibers may be toward the center of the star array.

In another embodiment of the invention, a self-powered, portable electronic device includes: a housing; ultra low power electronics housed within the housing; and high charge piezoelectric ceramic fibers and/or fiber composites for harvesting increased deliverable power from mechanical inputs to the portable electronic device. The piezoelectric ceramic fibers and/or fiber composites being electrically coupled to the ultra low power electronics to power the ultra low power electronics. The integration and convergence of ultra low power electronics and high charge piezoelectric ceramic fibers and/or fiber composites enable the self-powered, portable electronic device.

In another embodiment of the invention, a method of self-powering a portable electronic device is disclosed. The method includes: incorporating an energy harvesting system comprising piezoelectric ceramic fibers into a portable electronic device; positioning and orienting the piezoelectric ceramic fibers at one or more mechanical energy input points; generating a charge in the piezoelectric ceramic fibers from mechanical energy input at the mechanical energy input points, wherein the mechanical energy is input through normal use of the portable electronic device; collecting the charge from the piezoelectric ceramic fibers using electrical circuitry; storing the charge from the piezoelectric ceramic fibers in an energy storage device; and powering one or more loads of the portable electronic device using the stored energy generated using the piezoelectric ceramic fibers.

Additional features and advantages of the invention will be made apparent from the following detailed description of illustrative embodiments that proceeds with reference to the accompanying drawings.

### BRIEF DESCRIPTION OF THE DRAWINGS

The invention is best understood from the following detailed description when read in connection with the accompanying drawings. Included in the drawings are the following Figures that show various exemplary embodiments and various features of the present invention:

FIG. 1 is a block diagram of an exemplary piezoelectric ceramic material energy harvesting system that may be used to self-power a powered portable electronic device;

FIG. 2A is a front view of an exemplary self-powered portable electronic device having piezoelectric ceramic fibers to harvest mechanical energy in the closed position;

FIG. 2B is a view of the exemplary self-powered portable electronic device of FIG. 2A in the open position;

FIG. 2C is an exploded view of another exemplary self-powered portable electronic device having piezoelectric ceramic fibers to harvest mechanical energy.

FIGS. 3A and 3B are perspective views of exemplary piezoelectric ceramic fiber composites;

FIG. 4 shows an exemplary multilayer piezoelectric fiber composite and method of making the composite;

FIG. 5 shows an exemplary piezoelectric fiber composite for charge generation;

FIG. 6 shows an exemplary electric voltage generation by piezoceramics;

FIGS. 7A-7C show several exemplary forms that a piezoelectric fiber composite may take;

FIGS. 8A and 8B show exemplary voltages that may be generated by the piezoelectric fibers in response to mechanical energy inputs;

FIG. 9 shows an exemplary piezoelectric ceramic fiber energy harvesting system for converting waste mechanical energy in to electrical energy or power for self-powering a feature of a portable electronic device;

FIG. 10 is a flow chart showing the generation, collection, and storage of electrical energy from mechanical energy inputs for powering a load of a portable electronic device;

FIG. 11 shows exemplary direct and converse piezoelectric effects;

FIGS. 12A and 12B show exemplary voltages that may be generated by the piezoelectric fibers in response to mechanical energy inputs;

FIG. 13A shows exemplary power generation for a range of applied forces;

FIG. 13B shows exemplary power generation for a range of frequencies;

FIG. 14A shows exemplary resonance frequencies for a range of thickness ratios;

FIG. 14B shows exemplary power generation for a range of thickness ratios;

FIG. 15A shows energy produced in a self-powered transmitter being used in a sport utility vehicle on a bumpy road;

FIG. 15B shows energy produced in a self-powered transmitter being used in a small car on a smooth road;

FIG. 16A illustrates a bike set up to be tested; and

FIG. 16B shows voltage produced by vibrating the bike of FIG. 16A.

### DETAILED DESCRIPTION OF ILLUSTRATIVE EMBODIMENTS

The present invention is directed to devices, systems, and methods having energy harvesting capabilities for self-powering portable electronic devices. In one embodiment, the portable electronic device includes energy harvesting capabilities for eliminating the dependency of the portable electronic device on external and/or replaceable power supplies. In another embodiment, the portable electronic device includes energy harvesting capabilities for reducing the dependency of the portable electronic device on external and/or replaceable power supplies.

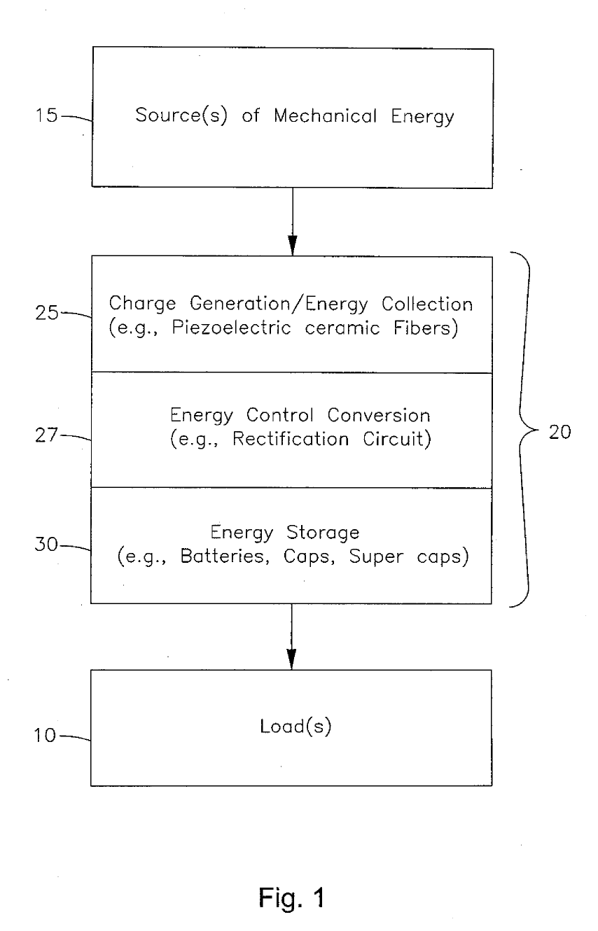

The self-powered device is capable of powering a load 10 from an ambient source of mechanical energy 15. As shown in FIG. 1, the self-powered device includes a piezoelectric ceramic material energy harvesting system 20 that provides for collection 25 of energy from the mechanical energy inputs 15 wherein the rate of energy may be below that required from the load 10. The energy harvesting system 20 shown in FIG. 1 also includes components and circuitry for conversion 27 and storage 30 of the harvested energy as electrical energy that may be used for powering the portable electronic device.

The energy harvesting system 20 preferably includes piezoelectric ceramic fibers (PZT, PLZT, or other electro-chemistries), rods, foils, composites, or other shapes (hereinafter referred to as “piezoelectric ceramic fibers”) that harvest mechanical energy 15 to provide electrical energy or power to operate one or more features of the portable electronic device. The piezoelectric ceramic fibers may be in and/or on a structure of the portable electronic device and/or auxiliary devices/structures associated with the portable electronic device.

The piezoelectric ceramic fiber energy harvesting system 20 may power the entire device and all of the various features of the device and/or may power select features of the device. As such, the use of piezoelectric active fibers for harvesting energy from the ambient sources of mechanical energy 15 provides a means to eliminate and/or reduce the need for external power sources and/or battery power.

Self-powered as used herein means autonomously generating electrical power using mechanical energy without the need for an external power supply. The self-powered device does not rely on replaceable batteries or rechargeable batteries that are charged from an external power supply for all of the device's power requirements. In other words, at least some of the device's electrical energy or power needs are fulfilled using the piezoelectric ceramic fiber energy harvesting system 20 that derives electrical energy or power from mechanical energy inputs 15.

The power collection system 25 preferably allows generation of charge in the piezoelectric ceramic fibers from mechanical inputs 15 seen in everyday use of a portable electronic device. For example, the mechanical energy of carrying and using the portable electronic device may be converted into electrical energy for powering the portable electronic device. Alternatively, artificial mechanical inputs 15 can be used to generate a charge. For example, a shaker-type stand can be used to hold and shake the wireless device during periods of inactivity, such as during the night when the device user is sleeping.

The mechanical energy 15 may include various sources of mechanical energy, including, for example, mechanical energy resulting from human activity and/or the operation of the device. For example, exemplary mechanical energy sources 15 can include: stress, strain, vibration, shock, motion, RF, EMI, etc. that may result from activities such as: walking, running, talking, opening, closing, sliding, pushing, shaking, scrolling, rotating, pivoting, swinging, and the like.

The harvested energy may be collected and stored in any suitable energy storage device or energy reservoir 30, such as, for example, batteries, rechargeable batteries (e.g., rechargeable lithium batteries), capacitors, super capacitors, etc. to enable operation of the portable electronic device and/or select features of the device. The storage device 30 may be electrically connected to the power generating device 25 via electrical circuitry 27, such as, for example, a flex circuit. Power control, conversion, and/or rectification circuitry may also be used. For example, a rectifier can be used to convert the energy from alternating current (AC) to direct current (DC) prior to storage. The rectifier may include a diode bridge. Mosfets, transistors, and other electronics may be used for directing and converting the harvested charge to a storage medium 30. The power may be stored for later use in powering a load and/or may be used to directly power a load of the portable electronic device.

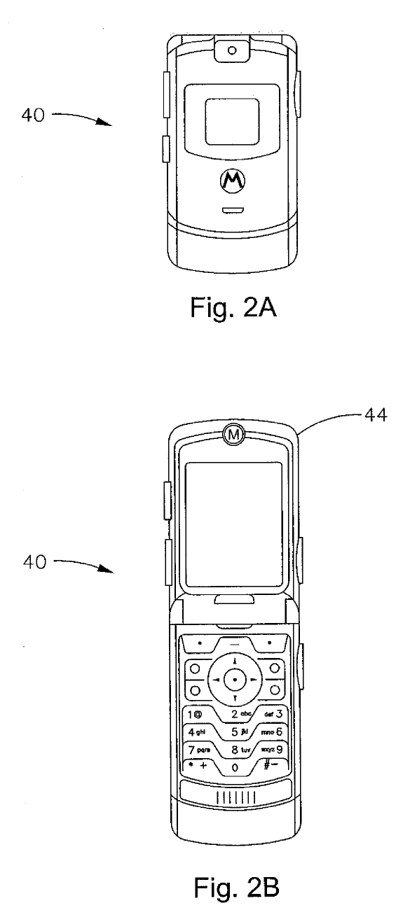

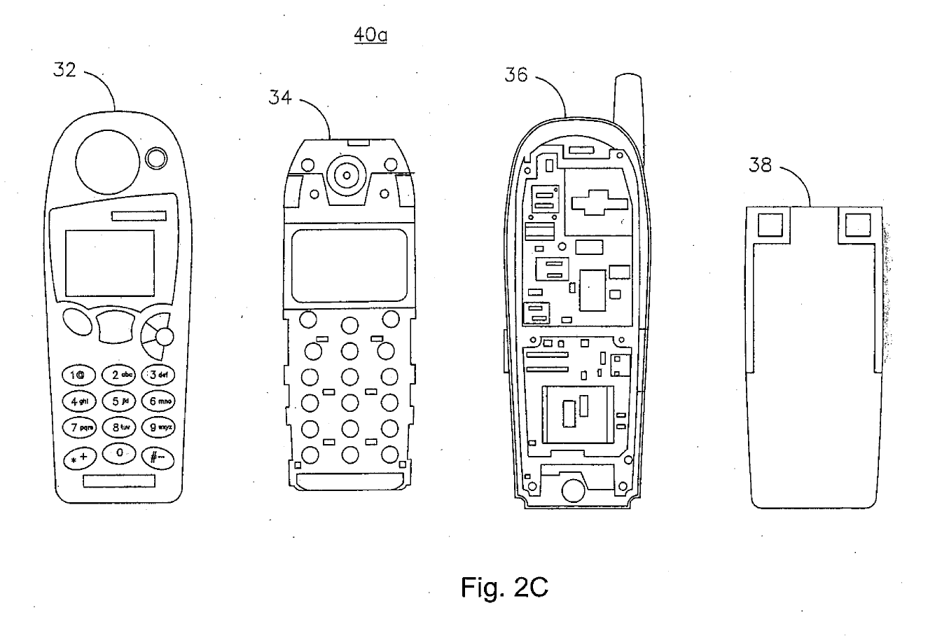

The portable electronic device may include, for example: wireless telephones (cellular telephones); portable digital assistants (PDA); wireless email devices (e.g., BlackBerry); wireless calendaring devices (e.g., Palm); portable gaming devices (e.g., GameBoy); instant messaging (IM) devices; text messaging devices; portable PCs; portable music players (e.g., iPod, MP3, etc.); voice, data services, short message service (SMS), multimedia messaging service (MMS), general packet radio service (GPRS) devices; global positioning systems (GPS); cameras; video recorders; other portable electronics, and the like. In the illustrated embodiments of FIGS. 2A-2C, the portable electronic device includes a cellular telephone 40/40a.

Piezoelectric materials exhibit a distinctive property known as the piezoelectric effect. Piezoelectric materials come in a variety of forms including crystals, plastics, and ceramics. Piezoelectric ceramic materials are essentially electromechanical transducers with special properties for a wide range of engineering applications. When subjected to mechanical inputs, such as, for example, stress from compression or bending, an electric field is generated across the material, creating a voltage gradient that generates a current flow. The piezoelectric ceramic material energy harvesting system of the present invention collects this electrical response to power one or more features of the portable electronic device.

Preferably, the portable electronic device comprises low or ultra low power electronics. Low or ultra low power electronics as used herein means electronic components that measure performance in micro and milliwatts levels (and in some cases nano-watts). Low or ultra low power electronics in addition to power conversion devices having increased efficiencies allows portable electronic devices to do more while consuming less power. The device electronics also preferably include state of the art electronics having, for example, low energy loads, low leakage, improved RF techniques, improved conversion techniques, increased storage capabilities, improved efficiencies, etc.

Examples of low or ultra low power electronics may include signal conditioners, controllers, RF transceivers, lights, speakers, microphones, ringers, displays, staying power, and the like. The electronics design can include power collection, power rectification, power storage, power regulation, tolerances, etc. Electrical circuits, such as analog circuits, may be used to convert, store, and regulate the piezo power.

The combination of low and ultra low power electronics and advances in energy harvesting capabilities provided by advanced, high charge piezoelectric ceramic fibers and fiber composite process technology allow for a self-powered portable electronic device. Piezoelectric ceramic fibers and fiber composites act as super transducers and offer increased deliverable power. The integration and convergence of ultra-low power electronics and advanced high charge piezoelectric ceramics enables a self-powered portable electronic device.

Piezoelectric ceramic fibers produced from Viscose Suspension Spinning Process (VSSP) are one example of advanced, high charge piezoelectric ceramic fibers. VSSP is a relatively low-cost technology that can produce superior fibers ranging from about 10 microns to about 250 microns. Methods of producing ceramic fibers using VSSP are disclosed, for example, in U.S. Pat. No. 5,827,797 and U.S. Pat. No. 6,395,080, the disclosures of which are incorporated herein by reference in their entirety.

The fibers can then be formed to user defined (shaped) composites based on specific applications and devices. The piezoelectric ceramic fibers may be disposed in, attached to, and/or embedded in one or more of the device enclosure, housing, cover, keypad, push buttons, slide buttons, switches, printed circuit board, display screen, ringer, antenna, holster, carrying case, belt, belt clip, etc. For example, the fibers can be embedded in an epoxy material that is then formed to be the device enclosure, such as a flip-open housing 44 of the cellular telephone 40 shown in FIGS. 2A and 2B. Additionally, the cellular telephone 40a of FIG. 2C includes a cover 32, a printed circuit board 34, a printed circuit board 36 and a battery 38. Accordingly, the cellular phone 40a may have fibers embedded in any one of the cover 32, the printed circuit board 34, the printed circuit board 36 and the battery 38.

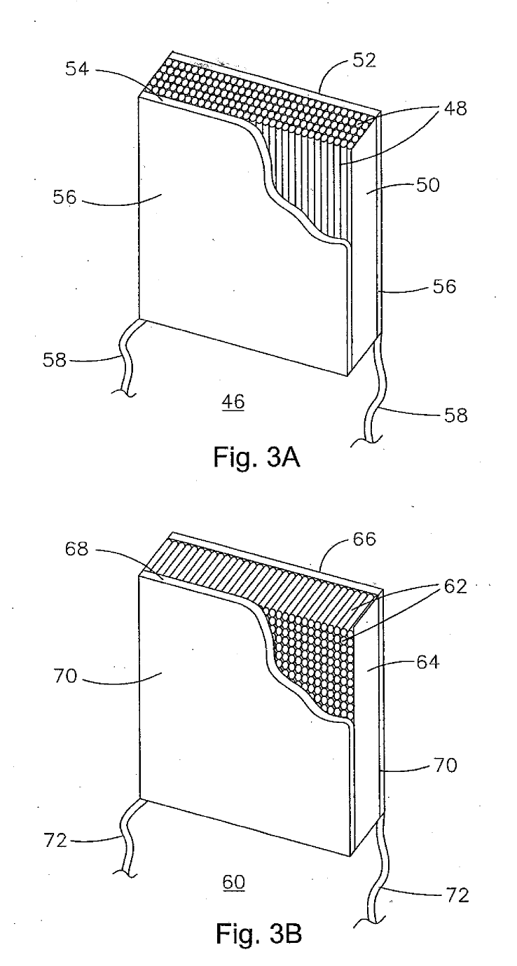

The fibers are preferably positioned and oriented so as to maximize the excitement of the fibers. In one embodiment, the piezoelectric ceramic fibers may be oriented in a parallel array with a poling direction of the fibers being in substantially the same direction. The fibers may be oriented along the length of the structure, as shown in FIG. 3A, or along the width or thickness of the structure, as shown in FIG. 3B.

As shown in FIG. 3A, a fiber composite 46 may include a plurality of individual fibers 48 of piezoelectric ceramic material disposed in a matrix material 50. As shown, the fiber composite 46 includes opposing sides 52, 54, which may be substantially planar and parallel to one another. As depicted, the fibers 48 are substantially parallel to the opposing sides 52, 54. As shown, the fiber composite 46 also includes electrodes 56 on each side from which extend electrical leads 58, respectively. Electrodes 56 can be used to collect the charge generated by the piezo fibers 48. It should be understood that other configurations of the fiber position and orientation are within the scope of the invention, for example, the fibers 48 may be at an angle (other than parallel) to the opposing sides 52, 54.

As shown in FIG. 3B, a fiber composite 60 may include a plurality of individual fibers 62 of piezoelectric ceramic material disposed in a matrix material 64. As shown, the fiber composite 60 includes opposing sides 66, 68, which may be substantially planar and parallel to one another. As depicted, the fibers 62 are substantially normal to the opposing sides 66, 68. As shown, the fiber composite 60 also includes electrodes 70 on each side from which extend electrical leads 72, respectively. Electrodes 70 can be used to collect the charge generated by the piezo fibers 62. It should be understood that other configurations of the fiber position and orientation are within the scope of the invention, for example, the fibers 62 may be at an angle (other than normal) to the opposing sides 66, 68.

In another embodiment (not shown), the piezoelectric ceramic fibers may be oriented in a star array having a center and the fibers extending outward from the center. The center may include, for example, a soft pliable gel with the fibers radiating outward from the center like porcupine needles. The poling direction of the fibers may be toward the center of the star array.

Preferably, the piezoelectric ceramic fibers are as long as possible for the given application. Generally, the longer the fiber, the more charge that may be generated for a given mechanical energy input. Accordingly, elongate fibers are preferably positioned and oriented to maximize the length of the fibers thus providing for increased amounts of harvested charge/power.

In addition, generally, the amount of charge increases as the number of fibers increases. As such, more charge may be generated for a given mechanical energy input by increasing the number and concentration of the fibers. For example, in one embodiment the fibers are positioned so that adjacent fibers are in contact with one another (although spacing may be provided between adjacent fibers). Accordingly, the fibers are preferably positioned and oriented to maximize the number and concentration of the fibers thus providing for increased amounts of harvested charge/power.

Preferably, the flexible fibers possess most if not all of the desirable properties of traditional ceramics (including electrical, thermal, chemical, mechanical, and the like) while at the same time eliminating some of the detrimental characteristics (such as brittleness, weight, and the like). Preferably, the piezoelectric ceramic fibers offer additional beneficial characteristics and features, such as light-weight (generally 35% of bulk), flexible and virtually unbreakable, user defined shapes and sizes, uniform crystal structure, higher power density, etc. Spun fibers have the ability to bend and as a result offer a more robust and flexible structure. Also, VSSP generated fibers are more efficient energy converters than traditional bulk ceramics (e.g., typically at least about 20-30% more efficient energy converters). For example, these spun fibers are dense and result in higher energy output than other materials, such as PVDF polymer. Another advantage of piezoelectric ceramic fibers of the energy harvesting system is that energy can be harvested as long as there is any mechanical energy input available.

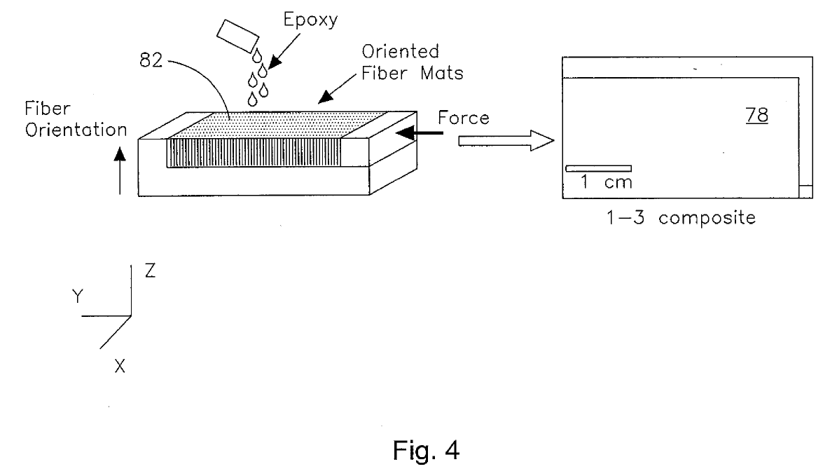

The energy generating system may also include processing of multilayer piezoelectric fiber composites. Processes for producing multilayer piezoelectric fiber composites are disclosed, for example, in U.S. Pat. No. 6,620,287, the disclosure of which is incorporated herein by reference in its entirety. As shown in FIG. 4, an exemplary multilayer piezoelectric fiber composite 78 may include fine sheets of parallel oriented piezoelectric fibers 82 in the z-direction. Preferably, sheet separation, volume fraction of ceramic, size and geometry can be tailored to the particular application during the manufacturing process.

In a preferred embodiment, the power generating mechanism comprises piezoelectric ceramic fiber and/or fiber composite materials developed and manufactured by Advanced Cerametrics, Inc. of Lambertville, N.J.

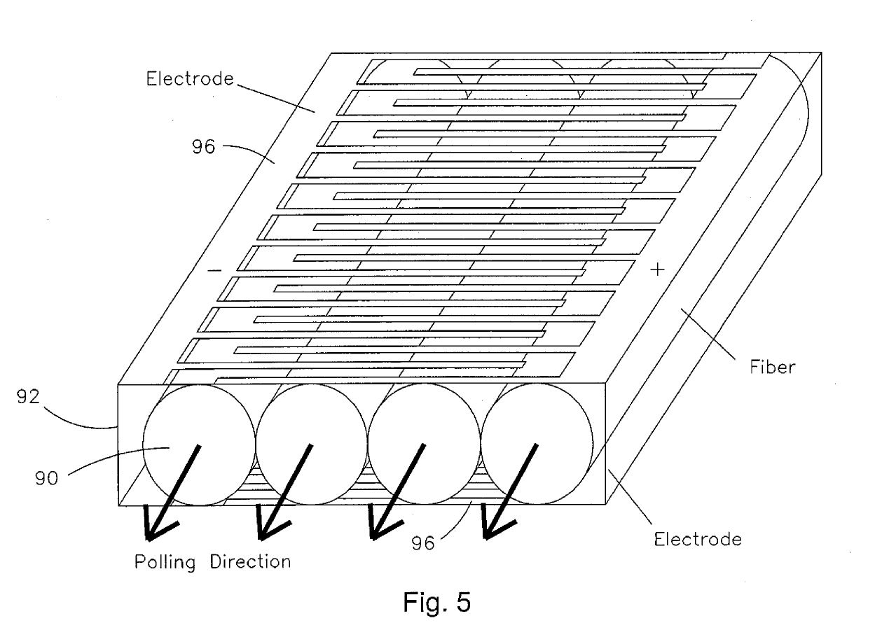

FIG. 5 shows piezoelectric fibers 90 for charge generation, a polymer matrix 92 for positioning, orientation, and load transfer, and electrodes 96 that may align the field with the fibers 90. Preferably, each piezoelectric energy harvesting system includes at least two electrodes 96 that may be terminated at one end of the piezoelectric energy harvesting system. The electrodes 96 may include interdigital electrodes. One of the electrodes 96 may be a positive terminal and the other may be a negative terminal. The electrode patterning, like the fibers, may be shape dependent.

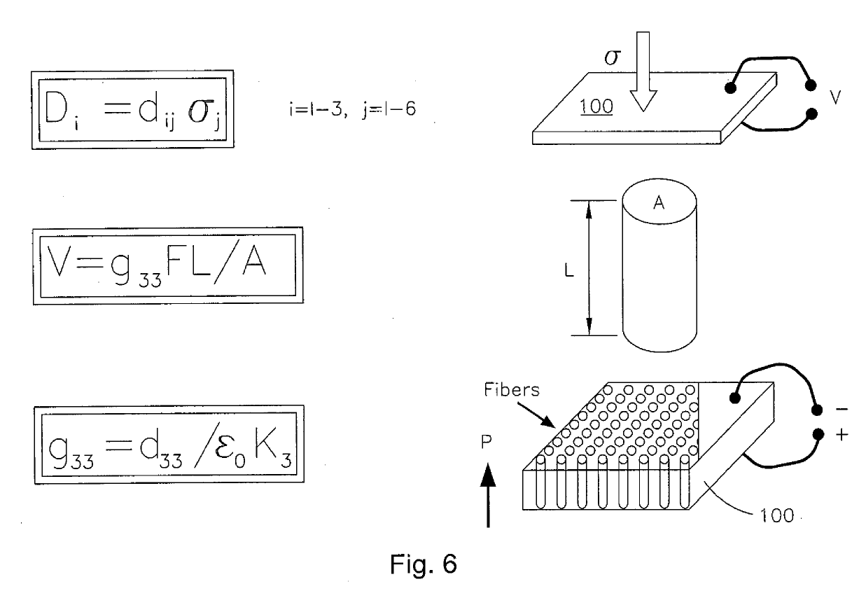

FIG. 6 shows an exemplary electric voltage generation of piezoceramics. As shown, piezoelectric materials 100 develop an electric charge proportional to an applied mechanical input (stress, strain, vibration, etc.).

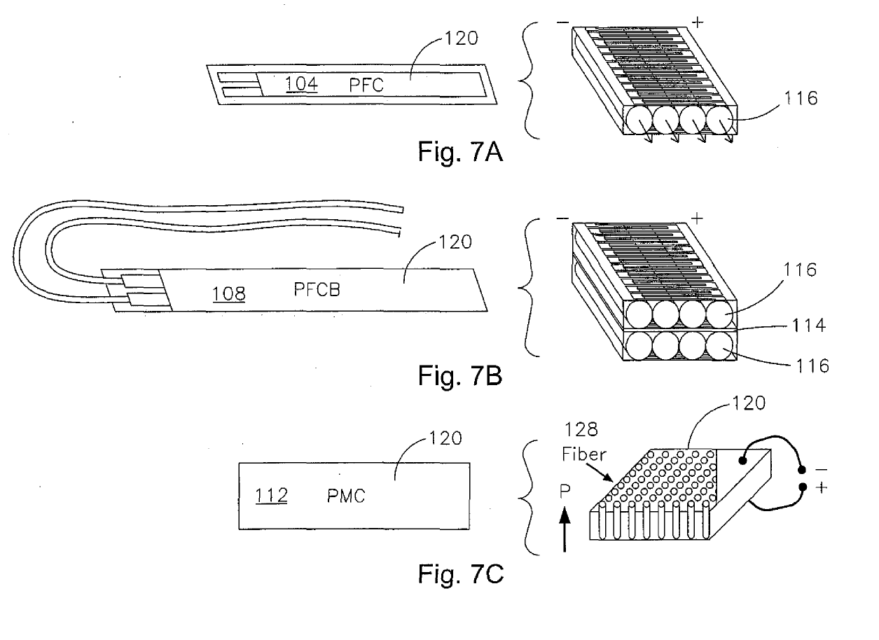

As shown in FIGS. 7A-7C, the piezoelectric energy harvesting system may include piezoelectric ceramic fibers in various forms, including, for example, a piezoelectric fiber composite (PFC) 104, a piezoelectric fiber composite bimorph (PFCB) 108, a piezoelectric multilayer composite (PMC) 112, etc. PFC 104 comprises a flexible composite piece of fiber 116 that may be embedded in an epoxy, a laminated piece, and/or other structure 120 of the device. PFCB 108 comprises two or more PFCs 104 connected together, either in series or in parallel, and attached to a shim 114 or a structure of the device. PMC 112 can include fibers 128 oriented in a common direction and typically formed in a block type or other user defined shapes and sizes.

PFC, PFCB, and PMC systems provide improved energy harvesting capabilities. The fibers are flexible even though they are ceramic and are designed and arranged to harvest (recover) waste energy from mechanical forces generated by humans and/or environmental conditions. The flexible fibers may be disposed in, embedded in, and/or affixed to the device structure. These mechanical forces can include any mechanical input energy, such as for example, motion, vibration, shock, compression, strain, and the like.

The piezoelectric ceramic fiber energy harvesting system generates and stores functional amounts of power. Functional amounts of power as used herein means an amount of power necessary to power and operate one or more features of a portable electronic device in which the piezoelectric fiber composite energy harvesting system may be disposed/attached/embedded and/or associated with.

The table below compares several energy harvesting options and illustrates the improved performance and efficiencies that may be achieved using piezoelectric fiber composites.

| Technology | Strength | Weakness |
|---|---|---|
| Solar power | Moderate costs, | 10-15% conversion |
| | abundant source | efficiency, only works |
| | | with sun light |
| Magnetic micro | Relatively high power | Moving parts, |
| generators | generation capability | expensive |
| Bulk piezoelectric | Cheap, 50-60% | Heavy, brittle, |
| ceramics | conversion efficiency | expensive to machine |
| Piezoelectric fiber | 70% transducer | |
| composites | efficiency, flexible, | |
| | inexpensive | |

Performance and conversion efficiencies of the piezoelectric ceramic fibers continue to improve as new electro-chemistries are developed and better components become available.

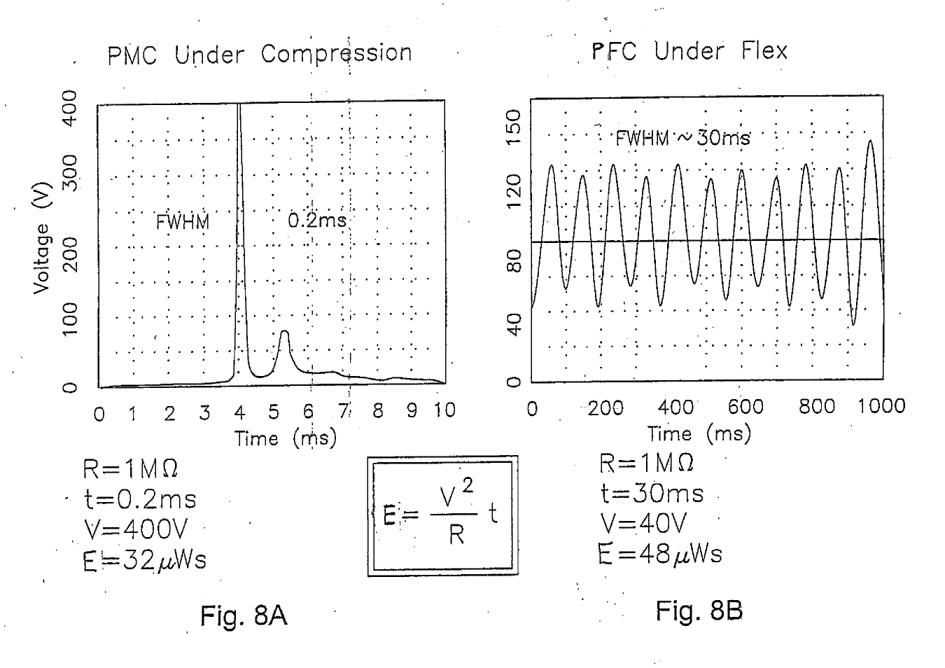

FIGS. 8A and 8B shows voltages that may be generated from an exemplary piezoelectric fiber composite. FIG. 8A illustrates a PMC under compressive loads and a DC spike that may be generated relative to the force applied. For the example shown, the following characteristics may be achieved: R=about 1MΩ, t=about 0.2 ms, V=about 400V, E=about 32 μWs.

FIG. 8B illustrates an PFC under flex and illustrates that the PFC will output a voltage relative to the applied force and direction. In the illustrated embodiment, the PFC is flexed and the resultant waveform is chopped DC, or a close approximation of AC. For the example shown, the following characteristics may be achieved: R=about 1MΩ, t=about 30 ms, V=about 40V, E=about 48 μWs.

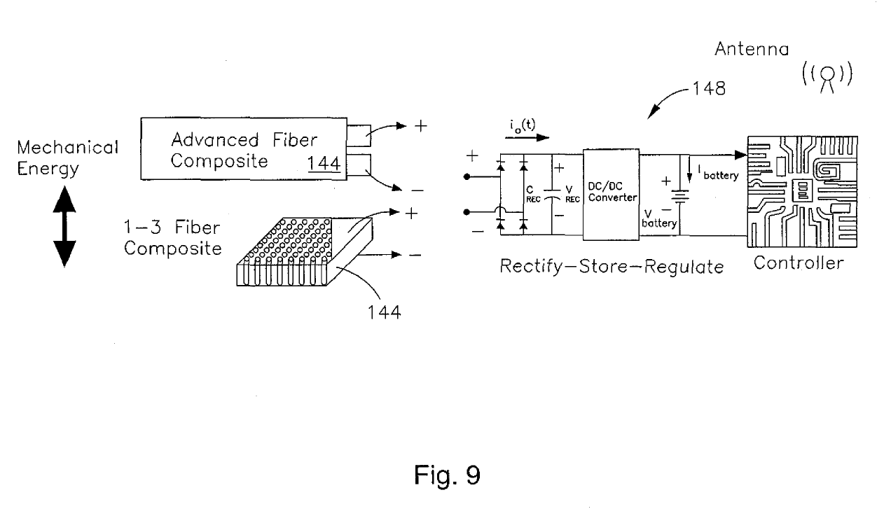

FIG. 9 shows an example of the lead zirconium titanate (PZT) fiber acting as an energy harvester to convert waste mechanical energy into a self-sustaining power source for an exemplary cellular telephone. Piezoelectric fibers capture the energy generated by the cell phone structure's vibration, compression, flexure, etc. The resulting energy (i.e., current) is used to charge up a storage circuit that then provides the necessary power level for some or all of the cell phone's electronics. In this example, energy is harvested by the vibration of PZT fiber composites 144. The energy is converted and stored in a low-leakage charge circuit 148 until a certain threshold voltage is reached. Once the threshold is reached, the regulated power may be allowed to flow for a sufficient period to power select loads of the cell phone, such as the transceiver.

In accordance with another embodiment, the piezoelectric fibers/composites may also convert mechanical energy directly into usable energy with no intervening electronics. For example, by harvesting energy from ambient vibrations, piezoelectric fibers/composites may provide electroluminescent lighting to, for example, the display, keypad, and other low-power lighting loads of the cellular telephone.

The piezo power capacity and output power is determined, at least in part, by the number or amount of piezo fibers, the size and form factor of the fibers/composite, and the mechanical forces (stress and strain, F=N) and frequencies (VIB=Hz). Useful amounts of power may be measured in micro and milliwatt levels (and in some cases nanowatts).

As way of example, an exemplary wireless telephone (cellular telephone) having GSM terminals may have a stand by mode of about 10 milliwatts, talking mode of about 300 milliwatts, and shut down mode of about 100 milliwatts. An exemplary digital assistant (PDA) as similar, as are Bluetooth devices. MP3 players typically use about 100 mW to power the headphones and 10 mW to process.

A typical single, piezoelectric fiber composite (PFC) may generate voltages in the range of about 40 Vp-p from vibration. A typical single, PFCB (bimorph) may generate voltages in the range of about 400-550 Vp-p with some forms reaching outputs of about 4000 Vp-p. As way of illustration, VSSP produced piezo fibers have the ability to produce about 880 mJ of storable energy in about a 13 second period when excited using a vibration frequency of 30 Hz. Other embodiments have the ability to produce about 1 J of storable energy. These energy levels are enough power to operate, for example, an LCD clock that consumes about 0.11 mJ/s for over approximately 20 hours.

The table below illustrates exemplary energy harvesting results for a plurality of different types of energy harvesting systems. As can be seen for the exemplary results, piezoelectric fiber composites (PFC) may offer superior power generation and storage possibilities over other types of energy harvesting systems.

| | | | | | | | Stored |
|---|---|---|---|---|---|---|---|
| | | Dimen. | Measure | | | Peak | energy in |
| Group | Transducer | (cm) | method | Mode | Vₚ₋ₚ | Power | 13 s(mJ) |
| Kyushu | PZT-5A disk | D-2.4 | Ball drop | d₃₃ | 120 | 450 μW | NA |
| NIRI, Japan | | T = 0.3 | | | | | |
| MIT | Multilayer | 8 × 10 | walking | d₃₃ & | 60 | 20 mW | 17 |
| | bimorph | | | d₃₁ | | | |
| | PVDF | | | | | | |
| MIT/NASA | Thunder | 7 × 9.5 × 0.05 | walking | d₃₁ & | 150 | 80 mW | 110 |
| | | | | d₁₅ | | | |
| Ocean Power | EEL PVDF | Five | Ocean | d₃₃ & | 3 | — | NA |
| Tech., Inc. | | 132 × 14 × 0.04 | waves | d₁₅ | | | |
| Univ. of | PZT-5A plate | 1 × 1 × 0.0009 | Tension | d₃₁ | | 2.3 μW | 0.3 |
| Pittsburgh | | 0.0009 | | | | | |
| Penn State | Quickpack | 5 × 3.8 × 0.07 | Vibration | d₃₃ | 43 | — | 169 |
| University | | | | | | | |
| Advanced | PFCB | 13 × 1 × 0.1 | Vibration | d₃₃ | 550 | 120 mW | 1,000 |
| Cerametrics, | | | (30 Hz) | | | | |
| Inc. | | | | | | | |

Preferably, the power output is scalable by combining two or more piezo elements in series or parallel, depending on the application. The composite fibers can be molded into unlimited user defined shapes and preferably are both flexible and motion sensitive. The fibers are preferably placed where there are rich sources of mechanical movement or waste energy. Examples of areas of mechanical energy input for an exemplary portable electronic device may include a flip open housing, a slide open housing, push buttons, slides, switches, scroll wheels, mounting cradles, holsters, carrying devices, stylus, hand grips or areas where a user picks up and/or holds the device when using the device, and the like.

A piezoelectric ceramic fiber energy harvesting system offers a less weight, less space, low cost solution to the power problems typically associated with portable electronic devices. A piezoelectric ceramic fiber energy harvesting system can be relatively easy to integrate into the form factor of typically portable electronic devices. Preferably, the physical packaging of the piezoelectric energy harvesting, conversion, and storage systems fit within an existing body or housing of the portable electronic device. More preferably, the piezoelectric energy generating, conversion, and storage systems occupy less space in the device body or housing of a portable electronic device than conventional power sources, such as batteries. For example, the piezo components preferably take the shape of the device itself. Alternatively, the entire or a portion of the piezo components may be located external to the device, such as in an auxiliary device/structure associated with the portable electronic device.

In another embodiment, the piezoelectric ceramic fiber energy harvesting system may comprise an extreme life-span micro-power supply. The extreme life-span micro-power supply has an extended life expectancy and the piezoelectric ceramic fibers will typically outlast the expected life of the other electronics in the device.

A piezoelectric ceramic fiber energy harvesting system may provide one or more of the following advantages/benefits over other types of power and other types of energy harvesting systems: reduce/eliminate dependency on external power source; reduce/eliminate dependency on batteries; eliminate battery replacement and battery disposal; make more portable by, for example, reducing/eliminating dependency on power cord; make more portable by, for example, reducing/eliminating dependency on charging station; reduce the size (smaller) of the portable electronic device by, for example, having the fibers conform to the shape of the device; reduce the weight (lighter) of the portable electronic device (piezoelectric ceramic fiber solutions are typically weighed in grams and not ounces as are other types of power systems); reduce the cost (cheaper) of the portable electronic device; enhance the service life of the electronic device; improved the reliability of the portable electronic device; providing a more robust design (generally the more energy encountered the more power generated) (e.g., active fibers can withstand a hammer strike without damage); reduced the maintenance and life cycle costs of owning and operating the portable electronic device; conversion of a higher percentage (up to about 70% or more) of energy from ambient mechanical sources to electrical power using piezoelectric fiber composites; improved performance over an extended life cycle; improve the overall quality of the portable electronic device; improving the operating experience for the user of the portable electronic device.

In accordance with another embodiment of the present invention, a method or integration path for the proper design and development of a self-powered electronic device is provided. The method includes the steps of determining the energy needs of the device and the particular application(s); inventorying ambient sources of mechanical energy (e.g., machines, structures, transporting means, human, device operation and handling, etc.); modeling and confirming the piezo power input; and determining and designing rectification, storage, and regulation needs.

Power is a key system parameter, so a detailed understanding of the device power requirements under various power dynamics is the first order of business. This may include, for example, voltage power up requirements, supply voltages, operating and maximum current requirements for individual components, optimum system power efficiencies, the power generating system, the power collection system, the power storage system, the power distribution system, and the like.

Another aspect that must be taken in to consideration is the space available for the power portion of the system. To save space and maximize the harvesting of as many sources of mechanical energy as possible, the ceramic fibers may be disposed/attached/embedded at various locations throughout the device. The layout of the power system should seek to save power and avoid unwanted voltage drops. Ground planes and/or shields can be used to reduce/prevent EMI and/or noise interaction.

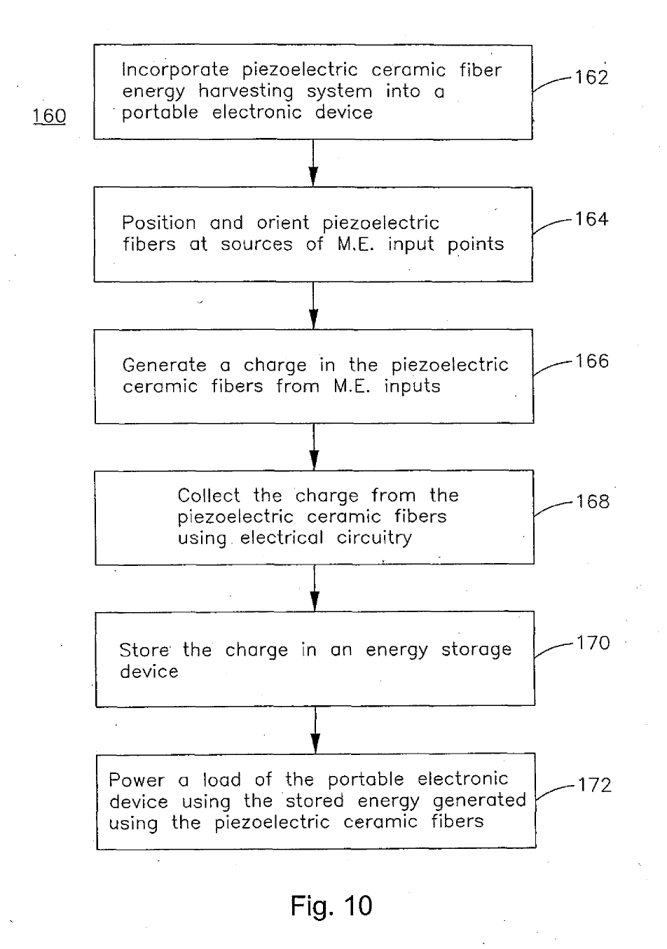

In accordance with another embodiment of the present invention, a method 160 of self-powering a portable electronic device is provided. As shown in FIG. 10, the method 160 may include incorporating an energy harvesting system 162 comprising piezoelectric ceramic fibers into a portable electronic device. The piezoelectric ceramic fibers may be positioned and oriented 164 at one or more mechanical energy input points. A charge is generated 166 in the piezoelectric ceramic fibers from mechanical energy input at one or more of the mechanical energy input points. Preferably, the mechanical energy is input through normal use of the portable electronic device. The charge may be collected 168 from the piezoelectric ceramic fibers using suitable electrical circuitry. The collected charge may be stored 170 in an energy storage device. The electrical energy may be conditioned (e.g., rectified) prior to storage. One or more loads of the portable electronic device may be powered 172 using the stored energy generated using the piezoelectric ceramic fibers.

In another embodiment (not shown), a belt and belt clip may comprise piezoelectric ceramic fibers and may be electrically coupled to one another. The belt clip may include an energy storage device and a male connector. Mechanical energy imparted to the belt and belt clip is collected and stored. When the electronic device is place in the belt clip, a female connector on the electronic device may connect to the male connector on the belt clip such that the electronic device is charged from the belt clip storage device.

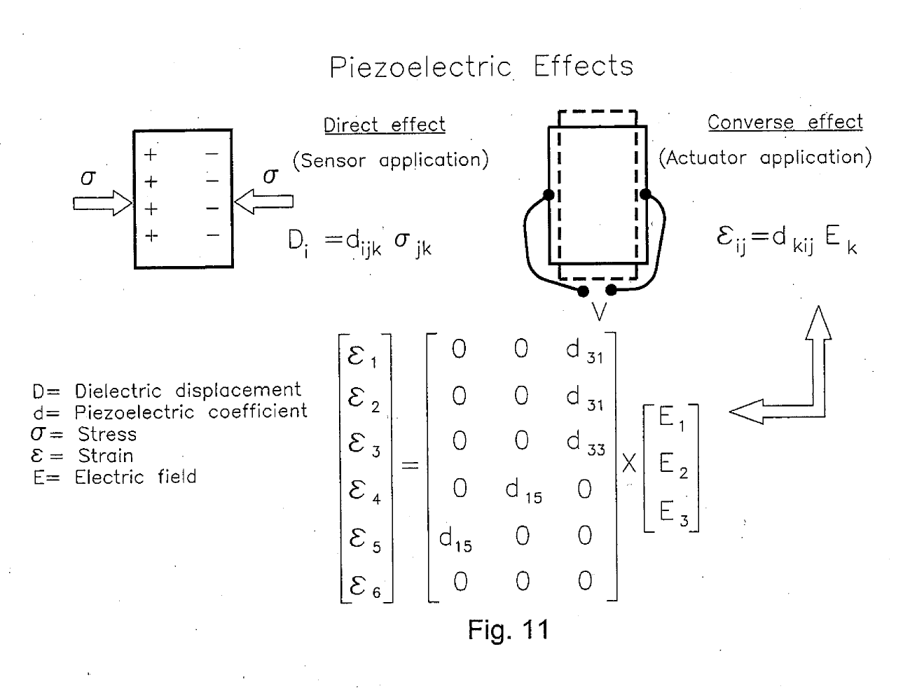

FIG. 11 illustrates direct and converse piezoelectric effect. As illustrated, the direct effect may be a sensor application and the converse effect may be an actuator application.

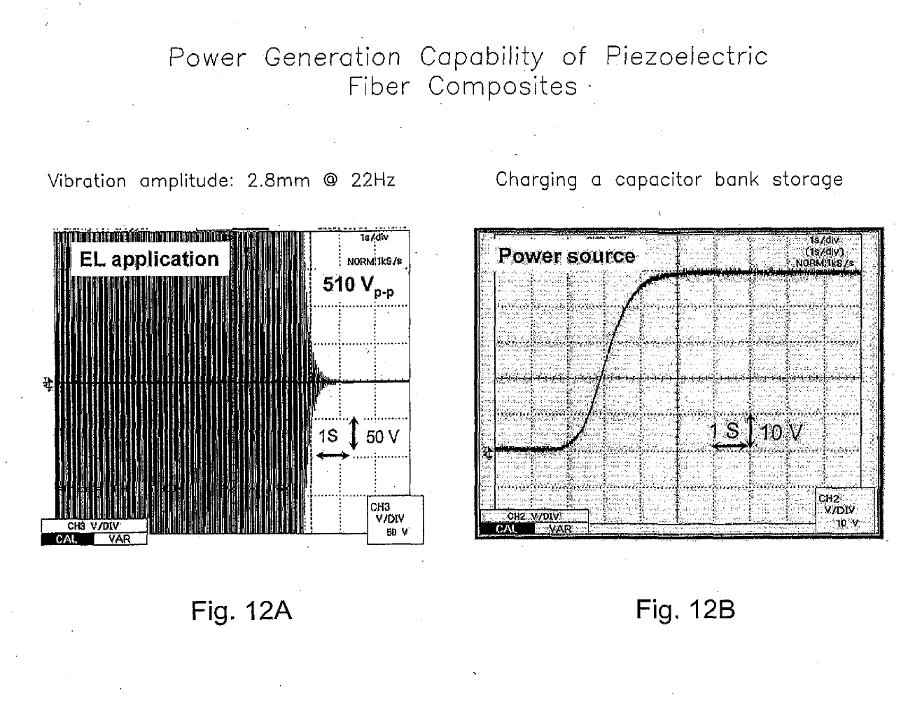

FIGS. 12A and 12B illustrate example power generation capabilities of exemplary piezoelectric fiber composites where the power generated was stored in a capacitor. FIG. 12A illustrates the AC voltage generated from an exemplary piezoelectric fiber composite. As illustrated, when the vibration amplitude is about 2.8 mm at about 22 Hz, a maximum output voltage of about 510 Vₚ₋ₚ may be produced. In FIG. 12A, each square represents 50 V in the vertical direction and 1 second in the horizontal direction. FIG. 12B illustrates how fast an exemplary capacitor may be charged. In FIG. 12B, each square represents 10 V in the vertical direction and 1 second in the horizontal direction. Accordingly, in the illustrated embodiment, a 400 μF capacitor bank may be charged to about 50 V in about 4 seconds. This may be sufficient power to run, for example, wireless sensors, illumination devices, alarms, audio components, visual displays, vibrating components, clocks, and other functional devices.

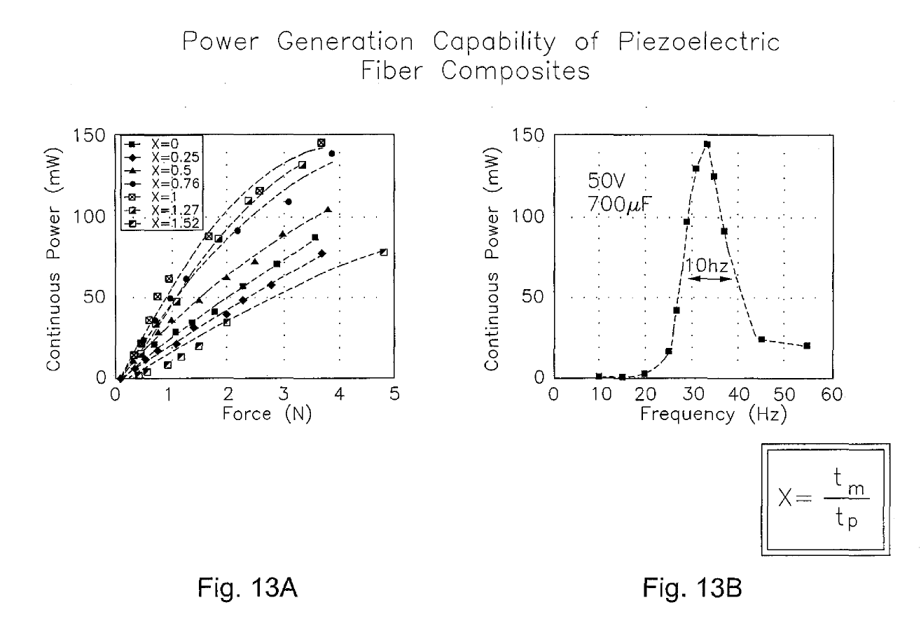

FIG. 13A illustrates exemplary power generation for a range of applied forces. The x-axis shows the force in Newtons and the y-axis shows the continuous power in milli-Watts. Each curve on the graph represents a PFCB with a specified thickness ratio between the piezoelectric material and the non-piezoelectric metal shims. X in FIG. 13A represents the ratio of metal thickness to the piezoelectric thickness. As illustrated, a maximum power output of about 145 mW was measured. Additionally, maximum power was generated at an equal metal/piezo ratio or when X=1.

FIG. 13B illustrates exemplary power generation for a range of frequencies or vibrations. As shown, much larger power may be generated at resonance. As shown, the PFCB tested had a resonance frequency of about 35 Hz. The graph shows that at such a frequency, a maximum power of about 145 mW may be produced. However, even at about 25 Hz and about 45 Hz a significant amount of power may be generated. Accordingly, a wide frequency peak may produce more power at random frequencies.

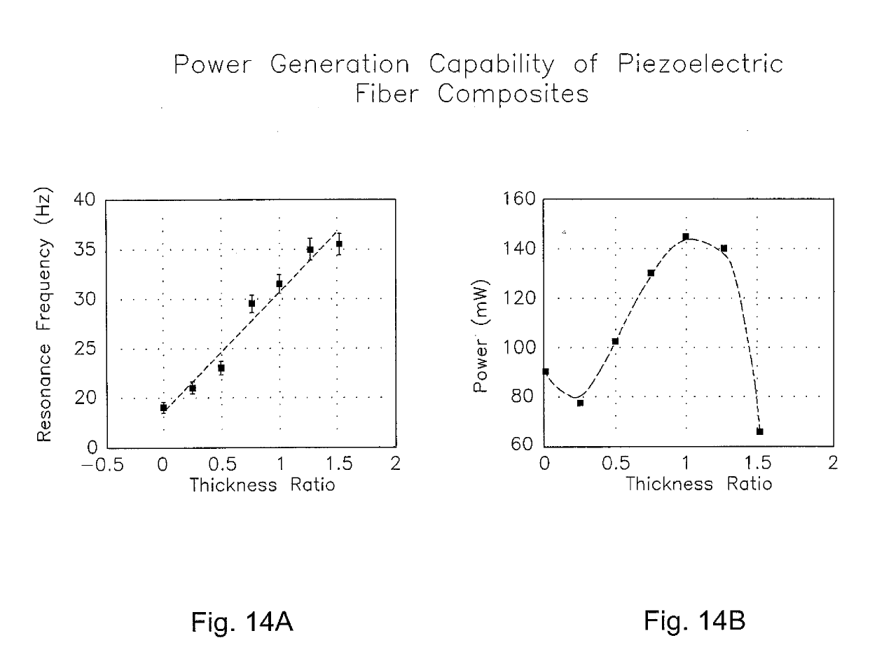

FIG. 14A illustrates exemplary resonance frequencies for a range of thickness ratios. According to the graph, a resonance frequency may be chosen to get maximum efficiency based on a particular application. For example, if a company has a compressor that works at 27 Hz, the thickness ratio may be modified to get a resonance frequency of 27 Hz so that maximum output may be achieved.

FIG. 14B illustrates exemplary power generation for a range of thickness ratios. As illustrated, maximum power is generated at about 33 Hz or when the thickness ratio is equal to about 1. It should be noted that much larger power may be generated in embodiments including bimorphs having metal shims. Furthermore, resonance frequency of EH transducers increased with metal/piezo thickness ratio.

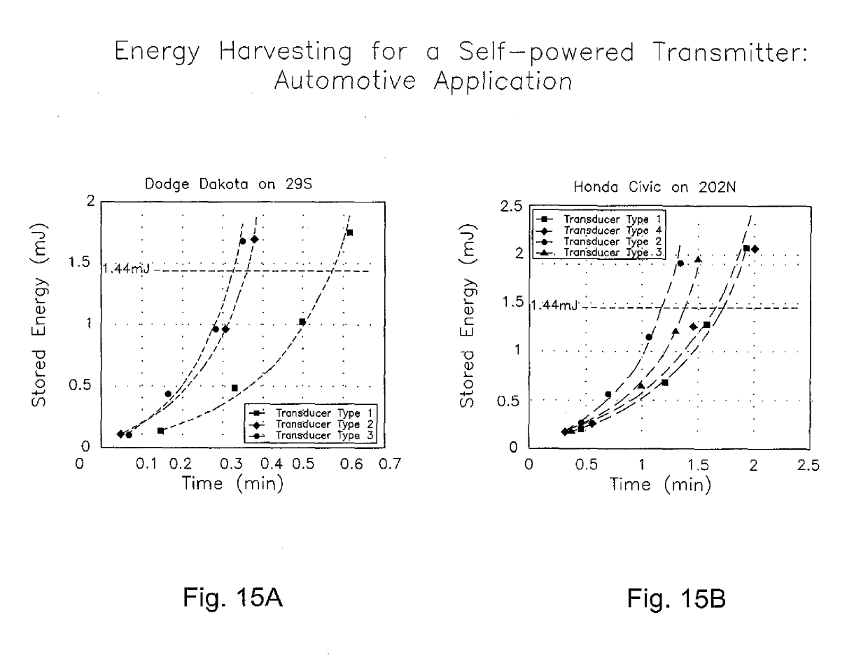

Energy harvesting may be used in transmitters, for example in transmitters used to pay tolls on a toll road. Self-powered transmitters were tested in several different vehicles driven on a bumpy road and on a smooth road to determine how long it would take to power the transmitter. The particular transmitter used required approximately 1.44 mJ to operate. FIG. 15A illustrates how long it took the self-powered transmitter to charge while being used in a sport utility vehicle (SUV) driven on a bumpy road. As illustrated, sufficient energy was produced in about 0.3 minutes to about 0.7 minutes depending on the transducer type used. FIG. 15B illustrates how long it took the self-powered transmitter to charge while being used in a small car driven on a smooth road. As illustrated, sufficient energy was produced in about 1.2 minutes to about 1.7 minutes depending on the transducer type used. Accordingly, all vehicles in all road types may produce sufficient energy to power the transmitter in about 0.3 minutes to about 1.2 minutes for one wireless transmission. The type two and type three transducers were low frequency transducers. Accordingly, it may be preferably to use a low frequency transducer.

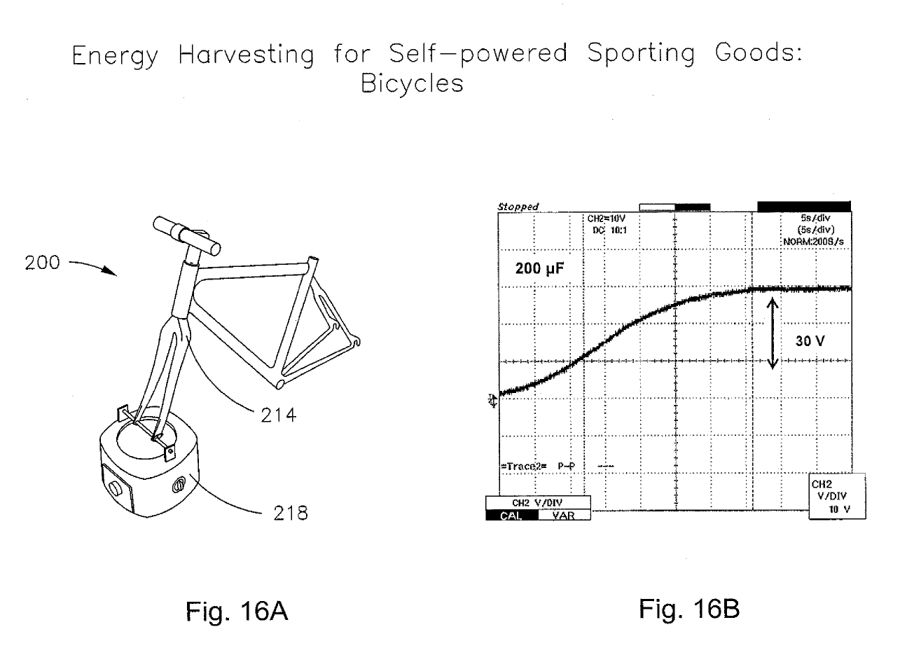

Energy harvesting may be used in sporting goods. For example as illustrated in FIGS. 16A and 16B a test was conducted on a bicycle 200 to determine how long it would take to power a computer (not shown) using piezoelectric fibers. The computer was capable of performing several functions such as calculating speed, temperature, time, etc. To perform the test, a front fork 214 of the bike 200 was placed on a shaker 218 to generate vibration. The bike 200 was vibrated moderately from the front fork 214 at about 14 Hz. The piezoelectric was placed just under the fork 214. As illustrated in FIG. 16B, it took approximately 5 seconds to generate about 30 V. Because the particular computer being powered only requires between 3.5-5.0 V the voltage may have to be reduced using conditioning circuitry. The amount of generated power may be optimized to a particular application based on, for example, the source of vibration level and the location of the transducer.

While systems and methods have been described and illustrated with reference to specific embodiments, those skilled in the art will recognize that modification and variations may be made without departing from the principles described above and set forth in the following claims. Accordingly, reference should be made to the following claims as describing the scope of disclosed embodiments.

What is claimed:

1. A self-powered electronic device comprising:
a housing;
one or more electrical components disposed in said housing wherein one or more of said one or more electrical components comprise electrical loads;
electrical circuitry associated with operation of said self-powered electronic device, said electrical circuitry electrically connecting said one or more electrical components;
a piezoelectric ceramic material electrically coupled to one or more of said electrical loads of said self-powered electronic device, wherein said piezoelectric ceramic material harvests and converts mechanical energy into electrical energy for powering one or more of said electrical loads.

2. The device of claim 1, wherein the one or more electrical components further comprise low or ultra low power electronics.

3. The device of claim 1, wherein said piezoelectric ceramic material harvests and converts mechanical energy into electrical energy for powering one or more of said electrical loads without use of an external power supply and/or a replaceable battery.

4. The device of claim 1, further comprising an energy harvesting system for capturing usable amount of electric energy from ambient sources of mechanical energy associated with handling and operation of said self-powered electronic device.

5. The device of claim 1, wherein said piezoelectric ceramic material generates an electrical charge in response to an applied mechanical energy input resulting from one or more of human activity and/or operation of said self-powered electronic device.

6. The device of claim 1, wherein said piezoelectric ceramic material further comprises piezoelectric ceramic fibers.

7. The device of claim 6, wherein said piezoelectric ceramic fibers further comprise one or more of: a piezoelectric fiber composite (PFC); a piezoelectric fiber composite bimorph (PFCB); and/or a piezoelectric multilayer composite (PMC).

8. The device of claim 1, wherein said piezoelectric ceramic material further comprises one or more of: fibers, rods, foils, composites, and multi-layered composites.

9. The device of claim 1, further comprising a piezoelectric energy harvesting system, wherein said piezoelectric energy harvesting system further comprises:
said piezoelectric ceramic material; and
electrical circuitry electrically connecting said piezoelectric ceramic material to said one or more electrical loads, wherein said piezoelectric energy harvesting system reduces a dependency of said self-powered electronic device on external and/or replaceable power supplies.

10. The device of claim 9, wherein said piezoelectric energy harvesting system eliminates any dependency of said self-powered electronic device on external and/or replaceable power supplies

11. The device of claim 1, wherein said piezoelectric ceramic material further comprises flexible, high charge piezoelectric ceramic fibers produced using Viscose Suspension Spinning Process (VSSP).

12. The device of claim 1, wherein said piezoelectric ceramic material further comprise user defined shapes and/or sizes.

13. The device of claim 1, wherein said piezoelectric ceramic material is one or more of: embedded within, disposed within, and/or attached to said self-powered electronic device.

14. The device of claim 1, further comprising:
a device or structure associated with said self-powered electronic device;
wherein said piezoelectric ceramic material is one or more of: embedded within, disposed within, and/or attached to said device or structure associated with the self-powered electronic device; and
electrical circuitry electrically coupling said self-powered electronic device to said device or structure associated with said self-power electronic device; and
wherein said self-powered electronic device receives a charge from said device or structure associated with said self-power electronic device.

15. The device of claim 4, wherein said energy harvesting system further comprises:
an energy storage device electrically coupled to said piezoelectric ceramic material for storing harvested energy; and
a rectifier electrically coupled between said energy storage device and said piezoelectric ceramic material, wherein said rectifier converts energy from alternating current (AC) to direct current (DC) prior to storage in said energy storage device.

16. The device of claim 6, wherein said piezoelectric ceramic fibers are positioned and oriented such that mechanical energy input is substantially in a direction parallel to a longitudinal axis of said fibers.

17. The device of claim 6, wherein said piezoelectric ceramic fibers are positioned and oriented to maximize a longitudinal length of said fibers.

18. The device of claim 6, wherein said piezoelectric ceramic fibers are positioned and oriented to maximize a number and concentration of said fibers.

19. The device of claim 6, wherein said piezoelectric ceramic fibers are oriented in parallel array with a poling direction of said fibers being in the same direction.

20. The device of claim 6, wherein adjacent piezoelectric ceramic fibers are in contact with one another.

21. The device of claim 6, wherein said piezoelectric ceramic fibers are oriented in a star array having a center and individual fibers extending outward from said center, wherein a poling direction of said fibers is toward said center of said star array.

22. A self-powered, portable electronic device comprising:
a housing;
ultra low power electronics housed within the housing; and
high charge piezoelectric ceramic fibers and/or fiber composites embedded within, disposed within, or attached to said portable electronic device, wherein said piezoelectric ceramic fibers and/or fiber composites harvest increased deliverable power from mechanical inputs to said portable electronic device;
wherein said piezoelectric ceramic fibers and/or fiber composites are electrically coupled to said ultra low power electronics to power said ultra low power electronics; and
wherein integration and convergence of ultra low power electronics and high charge piezoelectric ceramic fibers and/or fiber composites enable said portable electronic device to be partially or fully self-powered.

23. A method of self-powering an electronic device comprising:
(a) incorporating an energy harvesting system comprising a piezoelectric ceramic material into a portable electronic device;
(b) positioning and orienting the piezoelectric ceramic material at one or more mechanical energy input points;
(c) generating a charge in the piezoelectric ceramic material from a mechanical energy input at the mechanical energy input points,
(d) powering a load from the charge generated in the piezoelectric ceramic material.

24. The method of claim 23, wherein the load is powered directly from the charge generated in the piezoelectric ceramic material.

25. The method of claim 23 further comprising the step of collecting the charge from the piezoelectric ceramic material using electrical circuitry.

26. The method of claim 25 further comprising the step of storing the charge from the piezoelectric ceramic material in an energy storage device.

27. The method of claim 26, wherein the load is powered using the stored energy.

28. The method of claim 23, wherein the mechanical energy is input through normal use of the portable electronic device.

29. The method of claim 23, wherein the piezoelectric ceramic material comprises piezoelectric ceramic fibers.

30. The method of claim 29, wherein the piezoelectric ceramic fibers comprise one or more of: a piezoelectric fiber composite (PFC); a piezoelectric fiber composite bimorph (PFCB); and/or a piezoelectric multilayer composite (PMC).

31. A self-powered, portable electronic device comprising:
a housing;
electronics housed within the housing;
a piezoelectric ceramic material for harvesting increased deliverable power from mechanical inputs to the portable electronic device, wherein the piezoelectric ceramic material is electrically coupled to the electronics to power the electronics.

32. The device of claim 31, wherein the piezoelectric ceramic material comprises piezoelectric ceramic fibers.

33. The device of claim 32, wherein the piezoelectric ceramic fibers comprise one or more of: a piezoelectric fiber composite (PFC); a piezoelectric fiber composite bimorph (PFCB); and/or a piezoelectric multilayer composite (PMC).

34. The device of claim 31, wherein the electronics are ultra low power electronics.

35. The device of claim 34, wherein integration and convergence of the ultra low power electronics and the piezoelectric ceramic material enables the self-powered, portable electronic device.
